(19) United States
(12) Patent Application Publication
(10) Pub. No.: US 2026/0301998 A1
(43) Pub. Date: Oct. 1, 2026

(54) SYSTEMS AND METHODS FOR CUSTOMIZING INSULATED FILAMENTS

(71) Applicant: Meta Platforms Technologies, LLC, Menlo Park, CA (US)

(72) Inventors: Kristy Alana Jost, Woodinville, WA (US); Daniel Myers, Kirkland, WA (US); Omar Awartani, Redmond, WA (US); Inhwan Kim, Seattle, WA (US); Brendon Allen Beardsley, Lake Stevens, WA (US); Mehdi Mehrabi, Seattle, WA (US); Marcos Antonio Santana Andrade, Jr., Seattle, WA (US); Li Yao, Kirkland, WA (US); Thomas John Farrell Wallin, Redmond, WA (US); Sujal Tipnis, Redmond, WA (US); Wenyang Pan, Redmond, WA (US)

(21) Appl. No.: 19/631,977

(22) Filed: Mar. 27, 2026

Related U.S. Application Data
(60) Provisional application No. 63/780,912, filed on Mar. 31, 2025.

(51) Int. Cl. H01B 13/14; H01B 7/02; H01B 7/04

(52) U.S. Cl. CPC H01B 13/145; H01B 7/0275; H01B 7/041

(57) ABSTRACT

A method of the subject technology includes loading a conductive material to at least one extruder component connected to a die configured to produce a shape of a filament, and loading an insulative material to at least one additional extruder component connected to the die. The method further includes simultaneously extruding the conductive material and the insulative material through the separate channels of the die and curing the insulative material of the filament. The die comprises separate channels for conductive segments and insulative segments of the filament.

### CROSS REFERENCE TO RELATED APPLICATIONS

This present application claims the benefit of priority under 35 U.S.C. § 119(e) to U.S. Provisional Application No. 63/780,912, filed Mar. 31, 2025, the disclosure of which is hereby incorporated by reference in its entirety for all purposes.

### TECHNICAL FIELD

The present disclosure generally relates to signal transmission, and more particularly, to systems and methods for customizing insulated filaments.

### BACKGROUND

Many computing devices are increasingly becoming more portable, such as various wearable devices and smart textiles. These types of devices often rely on wires and filaments that are used to transmit electrical signals between and within electronic components. In order to maintain wearability, these types of wires and filaments may need to be flexible and elastic to adjust to the movement of users. Additionally, they may also need proper insulation and strong connections to maintain electrical signals between components while avoiding exposing users to the electrical signals.

However, to manufacture such insulated filaments, some production methods may trade flexibility for a more stable filament and connections. For example, flexible printed circuits (FPCs) may be produced with finer detail and patterned wiring but may also be relatively stiff when printed on sheets of material. In this example, printed circuitry may be adhered to textile without being fully integrated. Other production methods may trade ease of connection and stability of electrical signals for more flexibility. For example, conductive yarn may remain flexible but can be difficult to connect to custom components or may have exposed wiring. Additionally, some methods of manufacturing that include a wide range of coating or masking techniques may be slow to produce a filament. Furthermore, existing methods of manufacturing may increase the encumbrance of wearable devices and decrease the user experience of wearing such devices.

### SUMMARY

According to some aspects, a method of the subject technology includes loading a conductive material to at least one extruder component connected to a die configured to produce a shape of a filament, and loading an insulative material to at least one additional extruder component connected to the die. The method further includes simultaneously extruding the conductive material and the insulative material through the separate channels of the die and curing the insulative material of the filament. The die comprises separate channels for conductive segments and insulative segments of the filament.

According to other aspects, a device of the subject technology includes a customized insulated filament that consists of a core formed of a conductive material, a shell formed of an insulative material surrounding the core, and a plurality of conductive pads to connect to exposed segments of conductive material. The customized insulated filament is fabricated using an extrusion process.

According to yet other aspects, a wearable device of the subject technology includes electronic circuitry and flexible electronic connectors including a customized insulated filament. The customized insulated filament consists of a core formed of a conductive material, a shell formed of an insulative material surrounding the core, and a plurality of conductive pads to connect to exposed segments of conductive material. The customized insulated filament is fabricated using an extrusion process and a die including multiple channels.

### BRIEF DESCRIPTION OF THE DRAWINGS

To easily identify the discussion of any particular element or act, the most significant digit or digits in a reference number refer to the figure number in which that element is first introduced.

FIG. 1 is a flow diagram illustrating an example of a method of manufacturing for customized insulated filaments, according to certain aspects of the disclosure.

FIG. 2 is a block diagram illustrating an example of a system of manufacturing for customized insulated filaments, according to certain aspects of the disclosure.

FIG. 3 is a block diagram illustrating another example of a system of manufacturing for customized insulated filaments, according to certain aspects of the disclosure.

FIG. 4 is a schematic diagram illustrating a cross-sectional view of an example of a customized insulated filament, according to certain aspects of the disclosure.

FIG. 5 is a schematic diagram illustrating a top view of an exemplary electronic device integrating the customized insulated filaments of the subject technology.

FIG. 6 is a schematic diagram illustrating an example of a wrist-wearable device using some aspects of the subject technology.

FIG. 7 is a diagram illustrating example block diagrams of a computing system corresponding to the wrist-wearable device of FIG. 6.

FIG. 8 is a schematic diagram illustrating an example of an augmented reality (AR) system using some aspects of the subject technology.

FIGS. 9A and 9B are schematic diagrams illustrating an example of a virtual reality (VR) system using some aspects of the subject technology.

FIG. 10 is a diagram illustrating example block diagrams of a computing system corresponding to the AR device of FIG. 8 and the VR device of FIGS. 9A-9B.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below describes various configurations of the subject technology and is not intended to represent the only configurations in which the subject technology may be practiced. The detailed description includes specific details for the purpose of providing a thorough understanding of the subject technology. Accordingly, dimensions may be provided in regard to certain aspects as non-limiting examples. However, it will be apparent to those skilled in the art that the subject technology may be practiced without these specific details. In some instances, well-known structures and components are shown in block diagram form in order to avoid obscuring the concepts of the subject technology.

It is to be understood that the present disclosure includes examples of the subject technology and does not limit the scope of the included clauses. Various aspects of the subject technology will now be disclosed according to particular but non-limiting examples. Various embodiments described in the present disclosure may be carried out in different ways and variations, and in accordance with a desired application or implementation.

In the following detailed description, numerous specific details are set forth to provide a full understanding of the present disclosure. It will be apparent, however, to one ordinarily skilled in the art, that embodiments of the present disclosure may be practiced without some of the specific details. In other instances, well-known structures and techniques have not been shown in detail so as not to obscure the disclosure.

Some aspects of the subject disclosure are generally directed to systems and methods for customizing insulated filaments. As will be explained in greater detail below, embodiments of the present disclosure may, by employing a single-step extrusion process, manufacture a flexible insulated filament with a conductive core. For example, the disclosed systems and methods may mix conductive and insulative materials separately and may use extruder components to combine them through a die. By extruding both the conductive and insulative materials at the same time, the systems and methods described herein may reduce manufacturing costs and time that are common with multi-step processes that build on layers, such as by using lamination or molding.

By designing separate channels in the die, the disclosed systems and methods may also add further conductive and insulative segments to either the conductive core or the insulative shell of the filament. For example, the systems and methods described herein may use simulation to design a wire and, subsequently, may design the die to inject a predetermined length of insulative material to the core or a length of conductive material to the shell. In this example, the conductive material added to the shell may connect with the conductive core material to provide an electrical connection at the surface of the filament. Furthermore, the disclosed systems and methods may enable the production of a continuous filament for long lengths of material while maintaining a consistent diameter of the final filament. The systems and methods described herein may then electronically dispose conductive pads at the surface of the filament where the conductive material of the shell provides an electrical connection between the conductive pad and the conductive core. Finally, the disclosed systems and methods may integrate the insulated filament with other electronic components using the conductive pads to fully integrate conductive elements into textile.

In addition, the systems and methods described herein may improve the functioning of a computing device by improving the ease of connection between insulated filaments and other electronic components and the structural integrity and flexibility of conductive wires with insulation. These systems and methods may also improve the fields of wearable technology and electronic wires by improving the flexibility and design of conductive fibers to enable integration with flexible materials and to improve the range of placement options. Thus, the disclosed systems and methods may improve over traditional methods of manufacturing insulated filaments and incorporating filaments into wearable technology.

Features from any of the embodiments described herein may be used in combination with one another in accordance with the general principles described herein. These and other embodiments, features, and advantages will be more fully understood upon reading the following detailed description in conjunction with the accompanying drawings and claims.

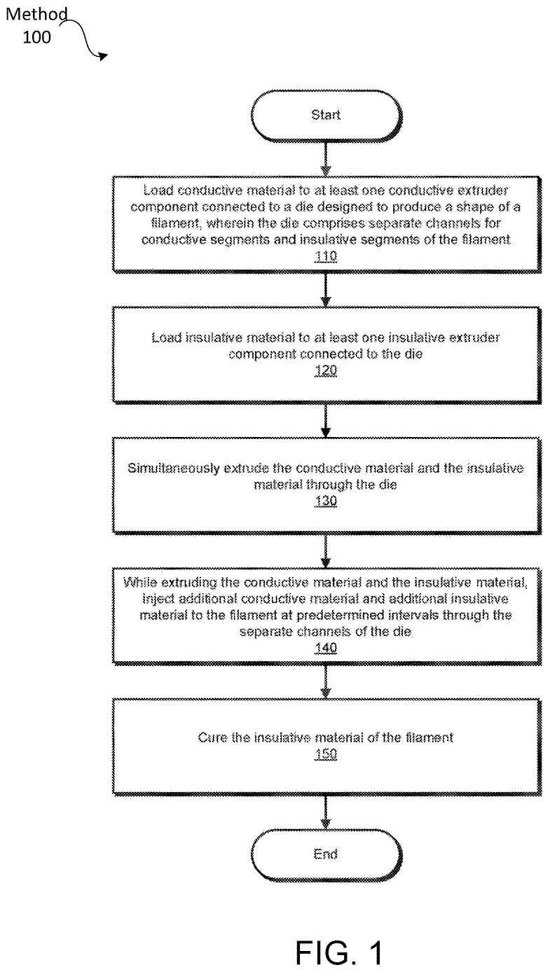

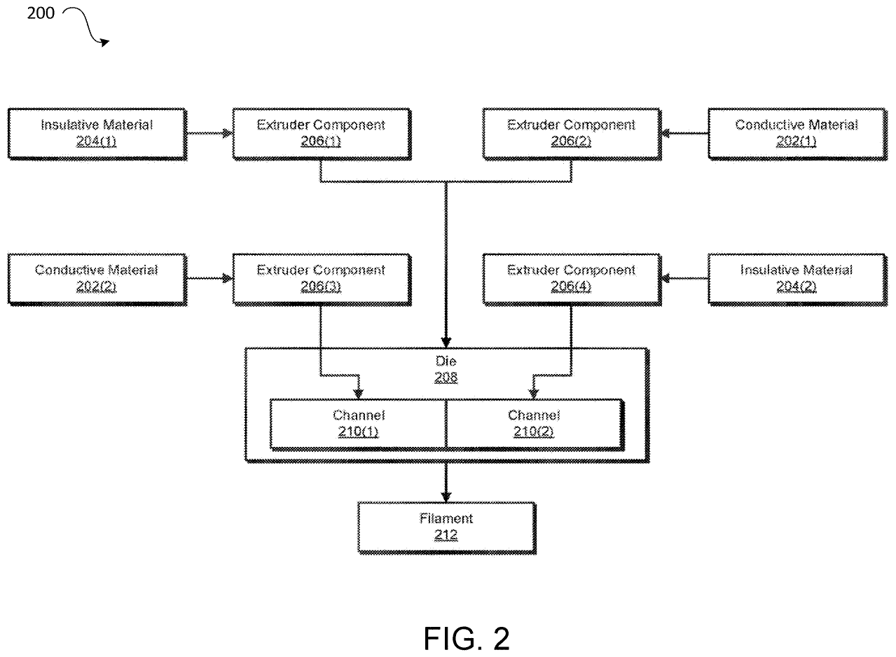

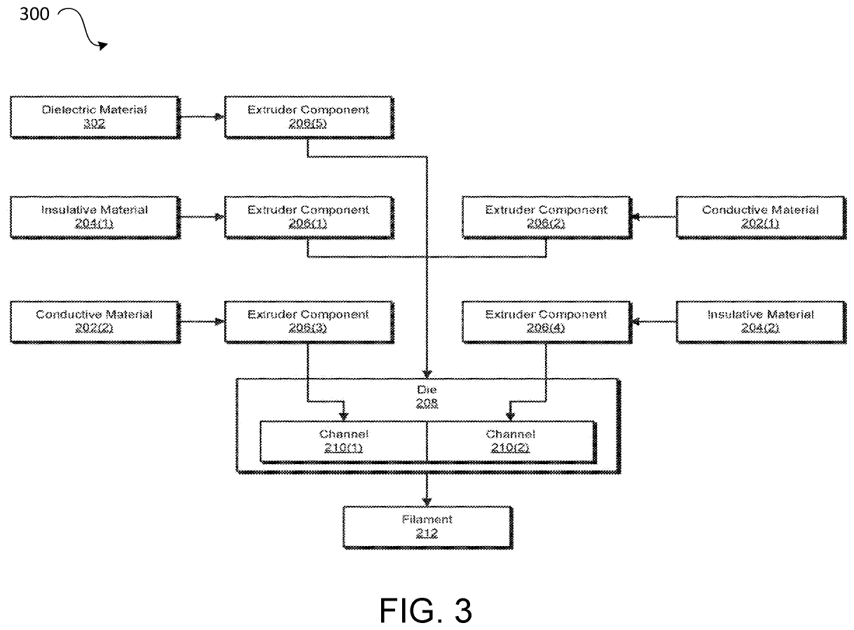

Turning now to the figures, FIG. 1 is a flow diagram illustrating an example of a method 100 of manufacturing for customized insulated filaments, according to certain aspects of the disclosure. The steps shown in FIG. 1 may be performed by any suitable system, including the systems illustrated in FIGS. 2-3. In one example, each of the steps shown in FIG. 1 may represent an algorithm whose structure includes and/or is represented by multiple sub-steps, examples of which will be provided in greater detail below.

As illustrated in FIG. 1, at step 110, one or more of the systems described herein may load conductive material to one or more extruder components connected to a die designed to produce a shape of a filament, wherein the die may include separate channels for conductive segments and insulative segments of the filament. The systems described herein may perform step 110 in a variety of ways. As used herein, the term “die” generally refers to a manufacturing tool that is customized to manipulate a material into a particular shape. The term “extruder,” as used herein, generally refers to a manufacturing tool that forces a material through a cross-section opening, such as an opening in a die.

At step 120, one or more of the systems described herein may load insulative material to one or more additional extruder components connected to the die. The systems described herein may perform step 120 in a variety of ways, as described below with respect to FIG. 2.

At step 130, one or more of the systems described herein may simultaneously extrude the conductive material and the insulative material through the die. The systems described herein may perform step 130 in a variety of ways, as described below with respect to FIGS. 2 and 3.

At step 140, one or more of the systems described herein may, while extruding the conductive material and the insulative material, inject additional conductive material and additional insulative material to the filament at predetermined intervals through the separate channels of the die. The systems described herein may perform step 140 in a variety of ways, as described below with respect to FIGS. 2 and 3.

At step 150, one or more of the systems described herein may cure the insulative material of the filament. The systems described herein may perform step 150 in a variety of ways, as described below with respect to FIG. 2. In some examples, method 100 of manufacturing may further include a step to dispose one or more conductive pads at a surface of filament 212 of FIG. 2 such that a conductive pad is connected to a segment of conductive material 202(2) of the shell, wherein the conductive pad electronically couples an electrical component with filament 212.

FIG. 2 is a block diagram illustrating an example of a system 200 of manufacturing for customized insulated filaments, according to certain aspects of the disclosure. In FIG. 2, a conductive material 202(1) may be loaded to an extruder component 206(2), a conductive material 202(2) may be loaded to an extruder component 206(3), and extruder components 206(2)-(3) may be connected to a die 208 designed to produce a shape of a filament 212.

In some examples, insulative materials 204(1)-(2) may be separately prepared from each other and/or separately from conductive materials 202(1)-(2). In the example of FIG. 2, insulative material 204(1) may be loaded to an extruder component 206(1), insulative material 204(2) may be loaded to an extruder component 206(4), and extruder components 206(1) and 206(4) may be connected to die 208 to produce filament 212 using the combination of conductive materials 202(1)-(2) and insulative materials 204(1)-(2).

In one embodiment, filament 212 may include a core comprising conductive material 202(1), a shell comprising insulative material 204(1), a segment of conductive material 202(2) of the shell, and a segment of insulative material 204(2) of the core. In this embodiment, the core may include material that may be solidified while maintaining flexibility or that may remain liquid in the final filament. For example, the core may include a liquid metal that provides flexibility and electrical conduction as conductive material 202(1) and remains liquid at room temperature. In this example, conductive material 202(2) of the shell may instead include a solidified material to provide a solid connection at the surface of filament 212. In this embodiment, insulative material 204(1) of the shell and/or insulative material 204(2) of the core may include any form of flexible material that provides non-conductive insulation. For example, insulative materials 204(1)-(2) may include silicone materials, polymer resins, acrylates, epoxies, and/or any other material that provides a predetermined minimum amount of flexibility and/or a low elastic modulus to resist deformation of the final filament. Furthermore, in some examples, insulative materials 204(1)-(2) may include UV-curable materials and/or materials with low viscosity.

In the above embodiments, the disclosed systems and methods may ensure that conductive materials 202(1)-(2) and insulative materials 204(1)-(2) are immiscible. In other words, conductive materials 202(1)-(2) and insulative materials 204(1)-(2) should not easily mix when added together to form filament 212.

FIG. 3 is a block diagram illustrating another example of a system 300 for manufacturing customized insulated filaments, according to certain aspects of the disclosure. The block diagram shown in FIG. 3 is an exemplary system of manufacturing an alternative version of filament 212 of FIG. 2. In this example, filament 212 may include additional materials such as a dielectric material 302 loaded to an extruder component 206(5) of FIG. 2, which may then be connected to die 208 to produce filament 212 when combined with conductive materials 202(1)-(2) of FIG. 2 and insulative materials 204(1)-(2) of FIG. 2. In this example, dielectric material 302 may also be immiscible to avoid mixing with conductive materials 202(1)-(2) and insulative materials 204(1)-(2). In other examples, additional materials and/or additional combinations of conductive and/or insulative materials may be added as needed to further extruder components connected to die 208, depending on the design of filament 212.

In some embodiments, the systems of FIG. 2 and/or FIG. 3 may extrude conductive material 202(1) and insulative material 204(1) through die 208 in a single step. In these embodiments, extruder component 206(1) and extruder component 206(2) may be connected to die 208 to produce a desired shape and size of filament 212, such that conductive material 202(1) and insulative material 204(1) form the desired shape and size as they exit die 208. In other embodiments, additional materials may be simultaneously extruded through die 208 to create the final shape and size of filament 212.

In one embodiment, die 208 of FIGS. 2-3 may include channels 210(1) and 210(2) to inject conductive material 202(2) and insulative material 204(2), respectively, to filament 212. In some examples, method 100 of FIG. 1 may further include a step to customize the conductive segments and the insulative segments of filament 212 by adjusting an injection of conductive material 202(2) and insulative material 204(2) through channels 210(1)-(2). In these examples, extruder components 206(3)-(4) may control the injection of conductive material 202(2) and insulative material 204(2) at specific intervals to create specific lengths of segments in the core and the shell of filament 212. During the extrusion process of step 130, conductive material 202(2) and insulative material 204(2) may simultaneously be injected into die 208 to create the final shape and size of filament 212. In other words, die 208 may include at least four inputs in FIG. 2 and at least five inputs in FIG. 3.

In some embodiments, the segmentation of the additional materials may be determined by a predetermined design of filament 212. For example, method 100 may use simulation to design the positioning and geometry of each segment of conductive material 202(2) in the shell and/or insulative material 204(2) in the core. In this example, the design may be determined by desired parameters for filament 212 and/or the behavior of the materials, such as fluid behavior and surface chemistry. In these embodiments, the design of filament 212 may be pre-programmed to control extruder components 206(1)-(4) to produce the desired lengths of insulative or conductive segments. In some embodiments, the injection of the additional materials may be performed by syringes or other precision dispensing devices through channels 210(1)-(2). Furthermore, the materials of each segment as well as the shell and core may be immiscible to avoid mixing during extrusion.

In the example of FIGS. 2 and 3, die 208 may include channels 210(1) and 210(2) to produce separate conductive segments and insulative segments for filament 212. In some examples, the systems of FIG. 2 and/or FIG. 3 may include other components, such as a computing device and a pump controller component, that control the materials loaded into extruder components 206(1)-(4) of FIG. 2 and/or extruder component 206(5) of FIG. 3. For example, a computing device may determine the mixtures and amounts of conductive materials 202(1)-(2), insulative materials 204(1)-(2), and/or dielectric material 302. In this example, conductive materials 202(1)-(2) may be similar or different, and insulative materials 204(1)-(2) may also be similar or different. In this example, the materials may be determined by the design of filament 212. In some examples, the systems of FIG. 2 and/or FIG. 3 may include one or more mixing blocks for mixing materials and one or more spinneret components that may be integrated with die 208 to feed the materials into die 208. For example, a more complex filament structure, such as a design with multiple cores and/or additional layers, may require a larger number of spinnerets to act as separate channels of die 208.

In one embodiment, insulative material 204(1) and/or insulative material 204(2) may include materials curable by ultraviolet (UV) light, such as UV-curable silicones and/or acrylates. In other embodiments, insulative material 204(1) and/or insulative material 204(2) may include soft materials with a particular modulus that may be integrated with textiles or other material for wearable devices. In various embodiments, filament 212 may then be handled or cut to a desired length after curing.

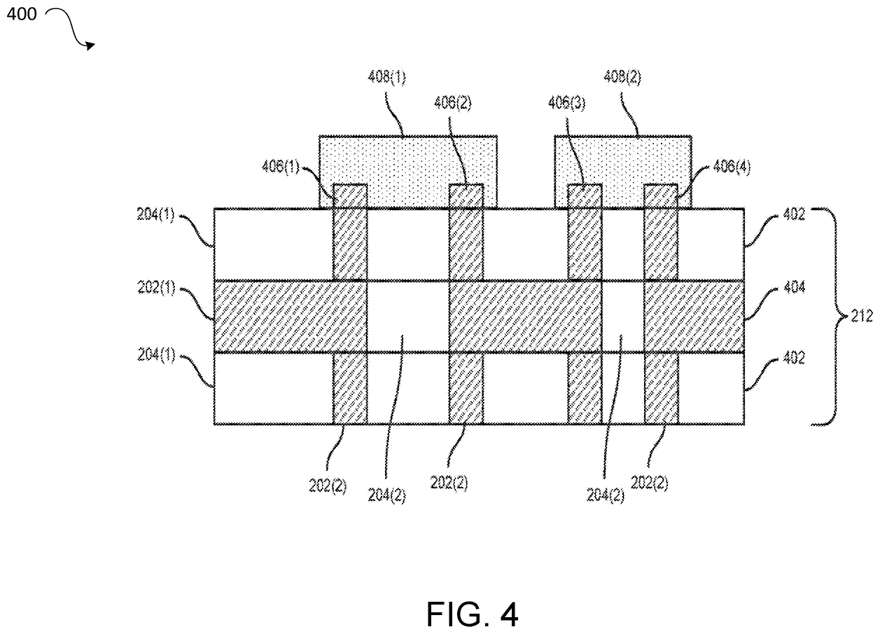

FIG. 4 is a schematic diagram illustrating a cross-sectional view 400 of an example of a customized insulated filament 212 of FIG. 2, according to certain aspects of the disclosure. In the example of FIG. 4, a core 404 of conductive material 202(1) is surrounded by a shell 402 of insulative material 204(1). In this example, conductive pads 406(1)-(4) may be disposed along the surface of filament 212 to connect to exposed segments of conductive material 202(2). Although illustrated as being symmetrical at the top and bottom of filament 212, the design of segments of conductive material 202(2) may be placed at any desired location along the circumference of filament 212. In the example of FIG. 4, electrical components 408(1)-(2) may be electronically coupled to conductive pads 406(1)-(4), which may then ensure electrical components 408(1)-(2) are connected to conductive core 404 of filament 212 and to each other.

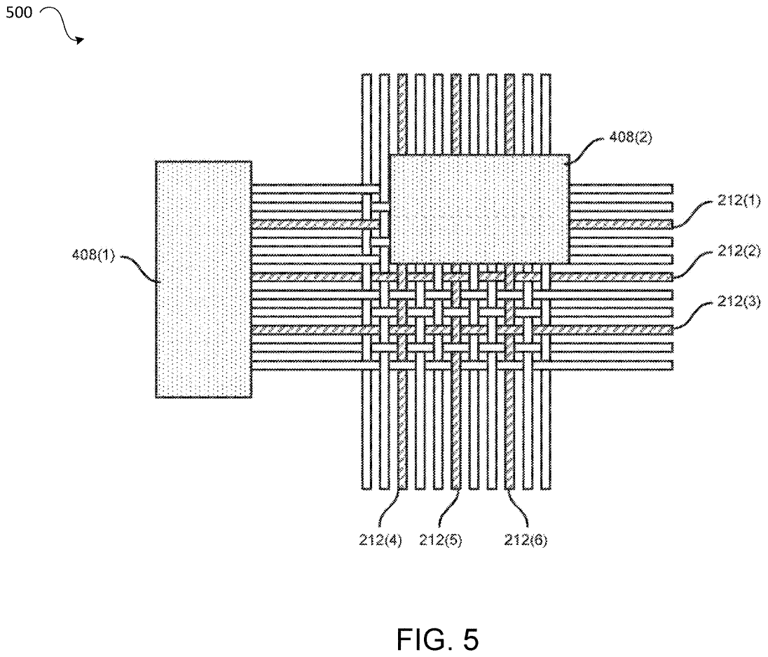

FIG. 5 is a schematic diagram illustrating a top view of an exemplary electronic device 500 integrating the customized insulated filaments of the subject technology. The integrated filaments are 212(1)-(6) of FIGS. 2 and 3 that are integrated into woven fiber to electronically couple electrical components 408(1)-(2) of FIG. 4. In this example, filaments 212(1)-(6) may be woven into a wearable fabric along with strands of fiber within the fabric. In some embodiments, electronic device 500 may represent wearable devices or any other form of computing device that may utilize conductive filaments. Examples of computing devices may include, without limitation, laptops, tablets, desktops, servers, cellular phones, Personal Digital Assistants (PDAs), multimedia players, embedded systems, wearable devices (e.g., smart watches, smart glasses, etc.), gaming consoles, medical devices, combinations of one or more of the same, or any other suitable computing device. As another example, electronic device 500 may include smart textiles and/or devices used for artificial or virtual reality (AR/VR) that may require flexible and stretchable conductors to route through electrical components 408(1)-(2).

As explained above in connection with method 100 of manufacturing in FIG. 1, the disclosed systems and methods may, by improving connection capabilities and customizability compared to traditional insulated wires, create flexible wires and conductive filaments with arbitrary conductive or insulative segments as needed. Specifically, the disclosed systems and methods may customize the size and location of conductive regions along a length of wire to improve performance and reliability of the electrical system. This customizability of connection points enables the disclosed systems and methods to expose conductive areas along a filament that are easier to connect to other electrical components. By integrating conductive elements that can be discreetly placed in the 2D structure of textiles, the disclosed systems and methods may also improve user experience and feel of wearing such textiles. Thus, the systems and methods described herein may improve the manufacturing and use of insulated filaments.

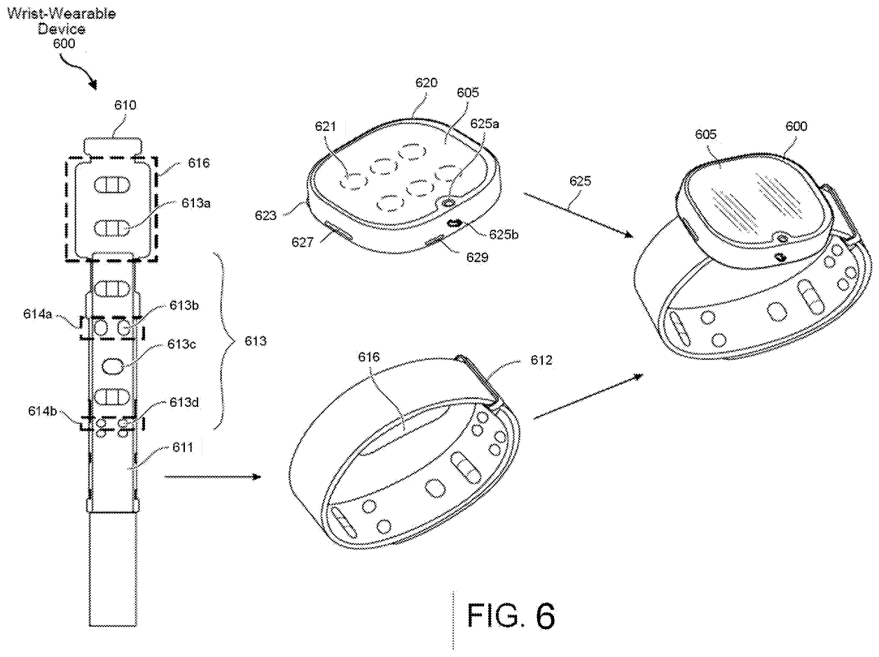

FIG. 6-10, presented below, provide information describing embodiments of computing devices and systems, such as electronic device 500 of FIG. 5, that may incorporate the disclosed insulated filament and method of manufacturing.

FIG. 6 is a schematic diagram illustrating an example of a wrist-wearable device using some aspects of the subject technology. FIG. 6 shows a wearable band 610 and a watch body 620 (or capsule) being coupled, as discussed below, to form wrist-wearable device 600. Wrist-wearable device 600 can perform various functions and/or operations associated with navigating through user interfaces and selectively opening applications.

As will be described in more detail below, operations executed by wrist-wearable device 600 can include (i) presenting content to a user (e.g., displaying visual content via a display 605), (ii) detecting (e.g., sensing) user input (e.g., sensing a touch on peripheral button 623 and/or at a touch screen of the display 605, a hand gesture detected by sensors (e.g., biopotential sensors)), and (iii) sensing biometric data (e.g., neuromuscular signals, heart rate, temperature, sleep, etc.) via one or more sensors 613, messaging (e.g., text, speech, video, etc.), image capture via one or more imaging devices or cameras 625, wireless communications (e.g., cellular, near field, Wi-Fi, personal area network, etc.), location determination, financial transactions, providing haptic feedback, providing alarms, providing notifications, providing biometric authentication, providing health monitoring, providing sleep monitoring, etc.

The above-example functions can be executed independently in watch body 620, independently in wearable band 610, and/or via an electronic communication between watch body 620 and wearable band 610. In some embodiments, functions can be executed on wrist-wearable device 600 while an AR environment is being presented. The wearable devices described herein can also be used with other types of AR environments.

Wearable band 610 can be configured to be worn by a user such that an inner surface of a wearable structure 611 of wearable band 610 is in contact with the user's skin. In this example, when worn by a user, sensors 613 may contact the user's skin. In some examples, one or more of sensors 613 can sense biometric data such as a user's heart rate, a saturated oxygen level, temperature, sweat level, neuromuscular signals, or a combination thereof. One or more of sensors 613 can also sense data about a user's environment including a user's motion, altitude, location, orientation, gait, acceleration, position, or a combination thereof. In some embodiments, one or more of sensors 613 can be configured to track a position and/or motion of wearable band 610. One or more of sensors 613 can include any of the sensors defined above and/or discussed below with respect to FIG. 6.

One or more of sensors 613 can be distributed on an inside and/or an outside surface of wearable band 610. In some embodiments, one or more of sensors 613 are uniformly spaced along wearable band 610. Alternatively, in some embodiments, one or more of sensors 613 are positioned at distinct points along wearable band 610. As shown in FIG. 6, one or more of sensors 613 can be the same or distinct. For example, in some embodiments, one or more of sensors 613 can be shaped as a pill (e.g., sensor 613a), an oval, a circle, a square, an oblong (e.g., sensor 613c) and/or any other shape that maintains contact with the user's skin (e.g., such that neuromuscular signals and/or other biometric data can be accurately measured at the user's skin). In some embodiments, one or more sensors of 613 are aligned to form pairs of sensors (e.g., for sensing neuromuscular signals based on differential sensing within each respective sensor). For example, sensor 613b may be aligned with an adjacent sensor to form sensor pair 614a and sensor 613d may be aligned with an adjacent sensor to form sensor pair 614b. In some embodiments, wearable band 610 does not have a sensor pair. Alternatively, in some embodiments, wearable band 610 has a predetermined number of sensor pairs (one pair of sensors, three pairs of sensors, four pairs of sensors, six pairs of sensors, sixteen pairs of sensors, etc.).

Wearable band 610 can include any suitable number of sensors 613. In some embodiments, the number and arrangement of sensors 613 depends on the particular application for which wearable band 610 is used. For instance, wearable band 610 can be configured as an armband, wristband, or chest-band that includes a plurality of sensors 613 with a different number of sensors 613, a variety of types of individual sensors with the plurality of sensors 613, and different arrangements for each use case, such as medical use cases as compared to gaming or general day-to-day use cases.

In accordance with some embodiments, wearable band 610 further includes an electrical ground electrode and a shielding electrode. The electrical ground and shielding electrodes, like the sensors 613, can be distributed on the inside surface of the wearable band 610 such that they contact a portion of the user's skin. For example, the electrical ground and shielding electrodes can be at an inside surface of a coupling mechanism 616 or an inside surface of a wearable structure 611. The electrical ground and shielding electrodes can be formed and/or use the same components as sensors 613. In some embodiments, wearable band 610 includes more than one electrical ground electrode and more than one shielding electrode.

Sensors 613 can be formed as part of wearable structure 611 of wearable band 610. In some embodiments, sensors 613 are flush or substantially flush with wearable structure 611 such that they do not extend beyond the surface of wearable structure 611. While flush with wearable structure 611, sensors 613 are still configured to contact the user's skin (e.g., via a skin-contacting surface). Alternatively, in some embodiments, sensors 613 extend beyond wearable structure 611 a predetermined distance (e.g., 0.1-2 mm) to make contact and depress into the user's skin. In some embodiments, sensors 613 are coupled to an actuator (not shown) configured to adjust an extension height (e.g., a distance from the surface of wearable structure 611) of sensors 613 such that sensors 613 make contact and depress into the user's skin. In some embodiments, the actuators adjust the extension height between 0.01 mm-1.2 mm. This may allow the user to customize the positioning of sensors 613 to improve the overall comfort of the wearable band 610 when worn while still allowing sensors 613 to contact the user's skin. In some embodiments, sensors 613 are indistinguishable from wearable structure 611 when worn by the user.

Wearable structure 611 can be formed of an elastic material, elastomers, etc., configured to be stretched and fitted to be worn by the user. In some embodiments, wearable structure 611 is a textile or woven fabric. As described above, sensors 613 can be formed as part of a wearable structure 611. For example, sensors 613 can be molded into the wearable structure 611, or be integrated into a woven fabric (e.g., sensors 613 can be sewn into the fabric and mimic the pliability of fabric and/or can be constructed from a series of woven strands of fabric).

Wearable structure 611 can include flexible electronic connectors that interconnect sensors 613, the electronic circuitry, and/or other electronic components (described below in reference to FIG. 5) that are enclosed in wearable band 610. In some embodiments, the flexible electronic connectors are configured to interconnect sensors 613, the electronic circuitry, and/or other electronic components of wearable band 610 with respective sensors and/or other electronic components of another electronic device (e.g., watch body 620). The flexible electronic connectors are configured to move with wearable structure 611 such that the user adjustment to wearable structure 611 (e.g., resizing, pulling, folding, etc.) does not stress or strain the electrical coupling of components of wearable band 610.

As described above, wearable band 610 is configured to be worn by a user. In particular, wearable band 610 can be shaped or otherwise manipulated to be worn by a user. For example, wearable band 610 can be shaped to have a substantially circular shape such that it can be configured to be worn on the user's lower arm or wrist. Alternatively, wearable band 610 can be shaped to be worn on another body part of the user, such as the user's upper arm (e.g., around a bicep), forearm, chest, legs, etc. Wearable band 610 can include a retaining mechanism 612 (e.g., a buckle, a hook and loop fastener, etc.) for securing wearable band 610 to the user's wrist or other body part. While wearable band 610 is worn by the user, sensors 613 sense data (referred to as sensor data) from the user's skin. In some examples, sensors 613 of wearable band 610 obtain (e.g., sense and record) neuromuscular signals.

The sensed data (e.g., sensed neuromuscular signals) can be used to detect and/or determine the user's intention to perform certain motor actions. In some examples, sensors 613 may sense and record neuromuscular signals from the user as the user performs muscular activations (e.g., movements, gestures, etc.). The detected and/or determined motor actions (e.g., phalange (or digit) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on display 605 of wrist-wearable device 600 and/or can be transmitted to a device responsible for rendering an AR environment (e.g., a head-mounted display) to perform an action in an associated AR environment, such as to control the motion of a virtual device displayed to the user. The muscular activations performed by the user can include static gestures, such as placing the user's hand palm down on a table, dynamic gestures, such as grasping a physical or virtual object, and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by sensors 613 can be used to provide a user with an enhanced interaction with a physical object (e.g., devices communicatively coupled with wearable band 610) and/or a virtual object in an AR application generated by an AR system (e.g., user interface objects presented on the display 605, or another computing device (e.g., a smartphone)).

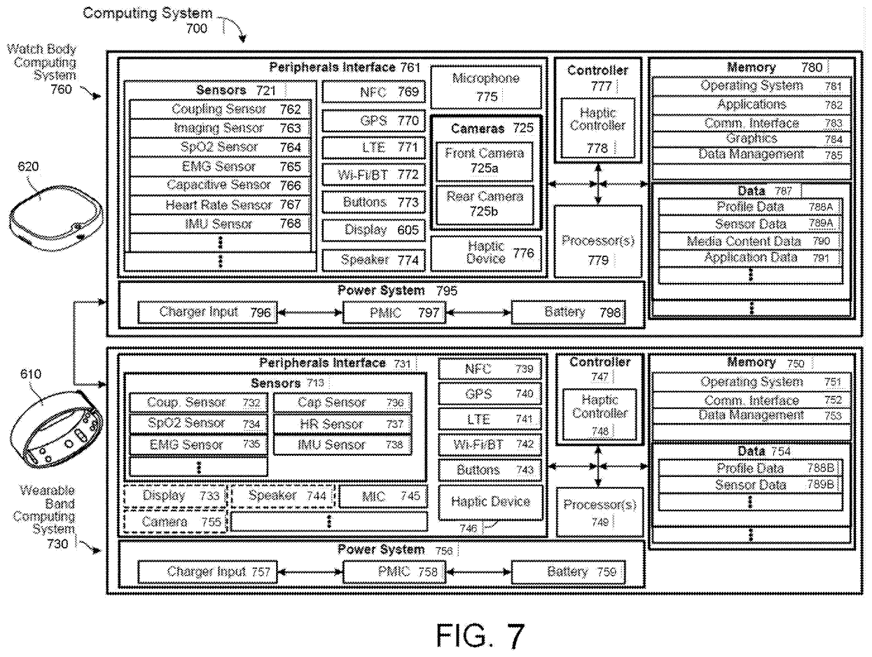

In some embodiments, wearable band 610 includes one or more haptic devices 776 (e.g., a vibratory haptic actuator) that are configured to provide haptic feedback (e.g., a cutaneous and/or kinesthetic sensation, etc.) to the user's skin. Sensors 613 and/or haptic devices 776 (shown in FIG. 7) can be configured to operate in conjunction with multiple applications including, without limitation, health monitoring, social media, games, and artificial reality (e.g., the applications associated with artificial reality).

Wearable band 610 can also include coupling mechanism 616 for detachably coupling a capsule (e.g., a computing unit) or watch body 620 (via a coupling surface of the watch body 620) to wearable band 610. For example, a cradle or a shape of coupling mechanism 616 can correspond to a shape of watch body 620 of wrist-wearable device 600. In particular, coupling mechanism 616 can be configured to receive a coupling surface proximate to the bottom side of watch body 620 (e.g., a side opposite to a front side of watch body 620 where display 605 is located), such that a user can push watch body 620 downward into coupling mechanism 616 to attach watch body 620 to coupling mechanism 616. In some embodiments, coupling mechanism 616 can be configured to receive a top side of the watch body 620 (e.g., a side proximate to the front side of watch body 620 where display 605 is located) that is pushed upward into the cradle, as opposed to being pushed downward into coupling mechanism 616. In some embodiments, coupling mechanism 616 is an integrated component of wearable band 610 such that wearable band 610 and coupling mechanism 616 are a single unitary structure. In some embodiments, coupling mechanism 616 is a type of frame or shell that allows watch body 620's coupling surface to be retained within or on wearable band 610 coupling mechanism 616 (e.g., a cradle, a tracker band, a support base, a clasp, etc.).

Coupling mechanism 616 can allow for watch body 620 to be detachably coupled to the wearable band 610 through a friction fit, magnetic coupling, a rotation-based connector, a shear-pin coupler, a retention spring, one or more magnets, a clip, a pin shaft, a hook and loop fastener, or a combination thereof. A user can perform any type of motion to couple the watch body 620 to wearable band 610 and to decouple the watch body 620 from the wearable band 610. For example, a user can twist, slide, turn, push, pull, or rotate watch body 620 relative to wearable band 610, or a combination thereof, to attach watch body 620 to wearable band 610 and to detach watch body 620 from wearable band 610. Alternatively, as discussed below, in some embodiments, the watch body 620 can be decoupled from the wearable band 610 by actuation of a release mechanism 629.

Wearable band 610 can be coupled with watch body 620 to increase the functionality of wearable band 610 (e.g., converting wearable band 610 into wrist-wearable device 600, adding an additional computing unit and/or battery to increase computational resources and/or a battery life of wearable band 610, adding additional sensors to improve sensed data, etc.). As described above, wearable band 610 and coupling mechanism 616 are configured to operate independently (e.g., execute functions independently) from watch body 620. For example, coupling mechanism 616 can include one or more sensors 613 that contact a user's skin when wearable band 610 is worn by the user, with or without watch body 620 and can provide sensor data for determining control commands.

A user can detach watch body 620 from wearable band 610 to reduce the encumbrance of wrist-wearable device 600 to the user. For embodiments in which watch body 620 is removable, watch body 620 can be referred to as a removable structure, such that in these embodiments wrist-wearable device 600 includes a wearable portion (e.g., wearable band 610) and a removable structure (e.g., watch body 620).

Turning to watch body 620, in some examples, watch body 620 can have a substantially rectangular or circular shape. Watch body 620 is configured to be worn by the user on their wrist or on another body part. More specifically, watch body 620 is sized to be easily carried by the user, attached on a portion of the user's clothing, and/or coupled to wearable band 610 (forming the wrist-wearable device 600). As described above, watch body 620 can have a shape corresponding to coupling mechanism 616 of wearable band 610. In some embodiments, watch body 620 includes a single release mechanism 629 or multiple release mechanisms (e.g., two release mechanisms 629 positioned on opposing sides of watch body 620, such as spring-loaded buttons) for decoupling watch body 620 from wearable band 610. Release mechanism 629 can include, without limitation, a button, a knob, a plunger, a handle, a lever, a fastener, a clasp, a dial, a latch, or a combination thereof.

A user can actuate release mechanism 629 by pushing, turning, lifting, depressing, shifting, or performing other actions on release mechanism 629. Actuation of release mechanism 629 can release (e.g., decouple) watch body 620 from coupling mechanism 616 of wearable band 610, allowing the user to use watch body 620 independently from wearable band 610 and vice versa. For example, decoupling watch body 620 from wearable band 610 can allow a user to capture images using rear-facing camera 625b. Although release mechanism 629 is shown positioned at a corner of watch body 620, release mechanism 629 can be positioned anywhere on watch body 620 that is convenient for the user to actuate. In addition, in some embodiments, wearable band 610 can also include a respective release mechanism for decoupling watch body 620 from coupling mechanism 616. In some embodiments, release mechanism 629 is optional and watch body 620 can be decoupled from coupling mechanism 616 as described above (e.g., via twisting, rotating, etc.).

Watch body 620 can include one or more peripheral buttons 623 and 627 for performing various operations at watch body 620. For example, peripheral buttons 623 and 627 can be used to turn on or wake (e.g., transition from a sleep state to an active state) display 605, unlock watch body 620, increase or decrease a volume, increase or decrease a brightness, interact with one or more applications, interact with one or more user interfaces, etc. Additionally or alternatively, in some embodiments, display 605 operates as a touch screen and allows the user to provide one or more inputs for interacting with watch body 620.

In some embodiments, watch body 620 includes one or more sensors 621. Sensors 621 of watch body 620 can be the same or distinct from sensors 613 of wearable band 610. Sensors 621 of watch body 620 can be distributed on an inside and/or an outside surface of watch body 620. In some embodiments, sensors 621 are configured to contact a user's skin when watch body 620 is worn by the user. For example, sensors 621 can be placed on the bottom side of watch body 620 and coupling mechanism 616 can be a cradle with an opening that allows the bottom side of watch body 620 to directly contact the user's skin. Alternatively, in some embodiments, watch body 620 does not include sensors that are configured to contact the user's skin (e.g., including sensors internal and/or external to the watch body 620 that are configured to sense data of watch body 620 and the surrounding environment). In some embodiments, sensors 621 are configured to track a position and/or motion of watch body 620.

Watch body 620 and wearable band 610 can share data using a wired communication method (e.g., a Universal Asynchronous Receiver/Transmitter (UART), a USB transceiver, etc.) and/or a wireless communication method (e.g., near field communication, Bluetooth, etc.). For example, watch body 620 and wearable band 610 can share data sensed by sensors 613 and 621, as well as application and device specific information (e.g., active and/or available applications, output devices (e.g., displays, speakers, etc.), input devices (e.g., touch screens, microphones, imaging sensors, etc.)).

In some embodiments, watch body 620 can include, without limitation, a front-facing camera 625a and/or a rear-facing camera 625b, sensors 621 (e.g., a biometric sensor, an IMU, a heart rate sensor, a saturated oxygen sensor, a neuromuscular signal sensor, an altimeter sensor, a temperature sensor, a bioimpedance sensor, a pedometer sensor, an optical sensor (e.g., imaging sensor 763), a touch sensor, a sweat sensor, etc.). In some embodiments, watch body 620 can include one or more haptic devices 776 (e.g., a vibratory haptic actuator) that is configured to provide haptic feedback (e.g., a cutaneous and/or kinesthetic sensation, etc.) to the user. Sensors 721 and/or haptic device 776 can also be configured to operate in conjunction with multiple applications including, without limitation, health monitoring applications, social media applications, game applications, and artificial reality applications (e.g., the applications associated with artificial reality).

As described above, watch body 620 and wearable band 610, when coupled, can form wrist-wearable device 600. When coupled, watch body 620 and wearable band 610 may operate as a single device to execute functions (operations, detections, communications, etc.) described herein. In some embodiments, each device may be provided with particular instructions for performing the one or more operations of wrist-wearable device 600. For example, in accordance with a determination that watch body 620 does not include neuromuscular signal sensors, wearable band 610 can include alternative instructions for performing associated instructions (e.g., providing sensed neuromuscular signal data to watch body 620 via a different electronic device). Operations of wrist-wearable device 600 can be performed by watch body 620 alone or in conjunction with wearable band 610 (e.g., via respective processors and/or hardware components) and vice versa. In some embodiments, operations of wrist-wearable device 600, watch body 620, and/or wearable band 610 can be performed in conjunction with one or more processors and/or hardware components.

As described below with reference to the block diagram of FIG. 7, wearable band 610 and/or watch body 620 can each include independent resources required to independently execute functions. For example, wearable band 610 and/or watch body 620 can each include a power source (e.g., a battery), a memory, data storage, a processor (e.g., a central processing unit (CPU)), communications, a light source, and/or input/output devices.

FIG. 7 is a diagram illustrating example block diagrams of a computing system corresponding to the wrist-wearable device of FIG. 6. The block diagram shown in FIG. 7 includes a block diagram of a computing system 730 corresponding to wearable band 610 and a computing system 760 corresponding to watch body 620, according to some embodiments. Computing system 700 of wrist-wearable device 600 may include a combination of components of wearable band computing system 730 and watch body computing system 760, in accordance with some embodiments.

Watch body 620 and/or wearable band 610 can include one or more components shown in watch body computing system 760. In some embodiments, a single integrated circuit may include all or a substantial portion of the components of watch body computing system 760 included in a single integrated circuit. Alternatively, in some embodiments, components of the watch body computing system 760 may be included in a plurality of integrated circuits that are communicatively coupled. In some embodiments, watch body computing system 760 may be configured to couple (e.g., via a wired or wireless connection) with wearable band computing system 730, which may allow the computing systems to share components, distribute tasks, and/or perform other operations described herein (individually or as a single device).

Watch body computing system 760 can include one or more processors 779, a controller 777, a peripherals interface 761, a power system 795, and memory (e.g., a memory 780). Power system 795 can include a charger input 796, a power-management integrated circuit (PMIC) 797, and a battery 798. In some embodiments, a watch body 620 and a wearable band 610 can have respective batteries (e.g., battery 798 and 759) and can share power with each other. Watch body 620 and wearable band 610 can receive a charge using a variety of techniques. In some embodiments, watch body 620 and wearable band 610 can use a wired charging assembly (e.g., power cords) to receive the charge. Alternatively, or in addition, watch body 620 and/or wearable band 610 can be configured for wireless charging. For example, a portable charging device can be designed to mate with a portion of watch body 620 and/or wearable band 610 and wirelessly deliver usable power to battery 798 of watch body 620 and/or battery 759 of wearable band 610. Watch body 620 and wearable band 610 can have independent power systems (e.g., power system 795 and 756, respectively) to enable each to operate independently. Watch body 620 and wearable band 610 can also share power (e.g., one can charge the other) via respective PMICs (e.g., PMICs 797 and 758) and charger inputs (e.g., 796 and 757) that can share power over power and ground conductors and/or over wireless charging antennas.

In some embodiments, peripherals interface 761 can include one or more sensors 721. Sensors 721 can include one or more coupling sensors 762 for detecting when watch body 620 is coupled with another electronic device (e.g., a wearable band 610). Sensors 721 can include one or more imaging sensors 763 (e.g., one or more of cameras 725, and/or separate imaging sensors 763 (e.g., thermal-imaging sensors)). In some embodiments, sensors 721 can include one or more SpO2 sensors 764. In some embodiments, sensors 721 can include one or more biopotential-signal sensors (e.g., EMG sensors 765, which may be disposed on an interior, user-facing portion of watch body 620 and/or wearable band 610). In some embodiments, sensors 721 may include one or more capacitive sensors 766. In some embodiments, sensors 721 may include one or more heart rate sensors 767. In some embodiments, sensors 721 may include one or more IMU sensors 768. In some embodiments, one or more IMU sensors 768 can be configured to detect movement of a user's hand or other location where watch body 620 is placed or held.

In some embodiments, one or more sensors 721 may provide an example human-machine interface. For example, a set of neuromuscular sensors, such as EMG sensors 765, may be arranged circumferentially around wearable band 610 with an interior surface of EMG sensors 765 being configured to contact a user's skin. Any suitable number of neuromuscular sensors may be used (e.g., between 2 and 20 sensors). The number and arrangement of neuromuscular sensors may depend on the particular application for which the wearable device is used. For example, wearable band 610 can be used to generate control information for controlling an augmented reality system, a robot, controlling a vehicle, scrolling through text, controlling a virtual avatar, or any other suitable control task.

In some embodiments, neuromuscular sensors may be coupled together using flexible electronics incorporated into the wireless device, and the output of one or more of the sensing components can be optionally processed using hardware signal processing circuitry (e.g., to perform amplification, filtering, and/or rectification). In other embodiments, at least some signal processing of the output of the sensing components can be performed in software such as processors 779. Thus, signal processing of signals sampled by the sensors can be performed in hardware, software, or by any suitable combination of hardware and software, as aspects of the technology described herein are not limited in this respect.

Neuromuscular signals may be processed in a variety of ways. For example, the output of EMG sensors 765 may be provided to an analog front end, which may be configured to perform analog processing (e.g., amplification, noise reduction, filtering, etc.) on the recorded signals. The processed analog signals may then be provided to an analog-to-digital converter, which may convert the analog signals to digital signals that can be processed by one or more computer processors. Furthermore, although this example is as discussed in the context of interfaces with EMG sensors, the embodiments described herein can also be implemented in wearable interfaces with other types of sensors including, but not limited to, mechanomyography (MMG) sensors, sonomyography (SMG) sensors, and electrical impedance tomography (EIT) sensors.

In some embodiments, peripherals interface 761 includes a near-field communication (NFC) component 769, a global-position system (GPS) component 770, a long-term evolution (LTE) component 771, and/or a Wi-Fi and/or Bluetooth communication component 772. In some embodiments, peripherals interface 761 includes one or more buttons 773 (e.g., peripheral buttons 623 and 627 in FIG. 6), which, when selected by a user, cause operation to be performed at watch body 620. In some embodiments, the peripherals interface 761 includes one or more indicators, such as a light emitting diode (LED), to provide a user with visual indicators (e.g., message received, low battery, active microphone and/or camera, etc.).

Watch body 620 can include at least one display 605 for displaying visual representations of information or data to a user, including user-interface elements and/or three-dimensional virtual objects. The display can also include a touch screen for inputting user inputs, such as touch gestures, swipe gestures, and the like. Watch body 620 can include at least one speaker 774 and at least one microphone 775 for providing audio signals to the user and receiving audio input from the user. The user can provide user inputs through microphone 775 and can also receive audio output from speaker 774 as part of a haptic event provided by haptic controller 778. Watch body 620 can include at least one camera 725, including a front camera 725a and a rear camera 725b. Cameras 725 can include ultra-wide-angle cameras, wide angle cameras, fish-eye cameras, spherical cameras, telephoto cameras, depth-sensing cameras, or other types of cameras.

Watch body computing system 760 can include one or more haptic controllers 778 and associated componentry (e.g., haptic devices 776) for providing haptic events at watch body 620 (e.g., a vibrating sensation or audio output in response to an event at the watch body 620). Haptic controllers 778 can communicate with one or more haptic devices 776, such as electroacoustic devices, including a speaker of the one or more speakers 774 and/or other audio components and/or electromechanical devices that convert energy into linear motion such as a motor, solenoid, electroactive polymer, piezoelectric actuator, electrostatic actuator, or other tactile output generating components (e.g., a component that converts electrical signals into tactile outputs on the device). Haptic controller 778 can provide haptic events that are capable of being sensed by a user of watch body 620. In some embodiments, one or more haptic controllers 778 can receive input signals from an application of applications 782.

In some embodiments, wearable band computing system 730 and/or watch body computing system 760 can include memory 780, which can be controlled by one or more memory controllers of controllers 777. In some embodiments, software components stored in memory 780 include one or more applications 782 configured to perform operations at the watch body 620. In some embodiments, one or more applications 782 may include games, word processors, messaging applications, calling applications, web browsers, social media applications, media streaming applications, financial applications, calendars, clocks, etc. In some embodiments, software components stored in memory 780 include one or more communication interface modules 783 as defined above. In some embodiments, software components stored in memory 780 include one or more graphics modules 784 for rendering, encoding, and/or decoding audio and/or visual data and one or more data management modules 785 for collecting, organizing, and/or providing access to data 787 stored in memory 780. In some embodiments, one or more of applications 782 and/or one or more modules can work in conjunction with one another to perform various tasks at the watch body 620.

In some embodiments, software components stored in memory 780 can include one or more operating systems 781 (e.g., a Linux-based operating system, an Android operating system, etc.). Memory 780 can also include data 787. Data 787 can include profile data 788A, sensor data 789A, media content data 790, and application data 791.

It should be appreciated that watch body computing system 760 is an example of a computing system within watch body 620, and that watch body 620 can have more or fewer components than shown in watch body computing system 760, can combine two or more components, and/or can have a different configuration and/or arrangement of the components. The various components shown in watch body computing system 760 are implemented in hardware, software, firmware, or a combination thereof, including one or more signal processing and/or application-specific integrated circuits.

Turning to the wearable band computing system 730, one or more components that can be included in wearable band 610 are shown. Wearable band computing system 730 can include more or fewer components than shown in watch body computing system 760, can combine two or more components, and/or can have a different configuration and/or arrangement of some or all of the components. In some embodiments, all, or a substantial portion of the components of wearable band computing system 730 are included in a single integrated circuit. Alternatively, in some embodiments, components of wearable band computing system 730 are included in a plurality of integrated circuits that are communicatively coupled. As described above, in some embodiments, wearable band computing system 730 is configured to couple (e.g., via a wired or wireless connection) with watch body computing system 760, which allows the computing systems to share components, distribute tasks, and/or perform other operations described herein (individually or as a single device).

Wearable band computing system 730, similar to watch body computing system 760, can include one or more processors 749, one or more controllers 747 (including one or more haptic controllers 748), a peripherals interface 731 that can include one or more sensors 713 and other peripheral devices, a power source (e.g., a power system 756), and memory (e.g., a memory 750) that includes an operating system (e.g., an operating system 751), data (e.g., data 754 including profile data 788B, sensor data 789B, etc.), and one or more modules (e.g., a communications interface module 752, a data management module 753, etc.).

One or more sensors 713 can be analogous to sensors 721 of watch body computing system 760. For example, sensors 713 can include one or more coupling sensors 732, one or more SpO2 sensors 734, one or more EMG sensors 735, one or more capacitive sensors 736, one or more heart rate sensors 737, and one or more IMU sensors 738.

Peripherals interface 731 can also include other components analogous to those included in peripherals interface 761 of watch body computing system 760, including an NFC component 739, a GPS component 740, an LTE component 741, a Wi-Fi and/or Bluetooth communication component 742, and/or one or more haptic devices 746 as described above in reference to peripherals interface 761. In some embodiments, peripherals interface 731 includes one or more buttons 743, a display 733, a speaker 744, a microphone 745, and a camera 755. In some embodiments, peripherals interface 731 includes one or more indicators, such as an LED.

It should be appreciated that wearable band computing system 730 is an example of a computing system within wearable band 610, and that wearable band 610 can have more or fewer components than shown in wearable band computing system 730, combine two or more components, and/or have a different configuration and/or arrangement of the components. The various components shown in wearable band computing system 730 can be implemented in one or more of a combination of hardware, software, or firmware, including one or more signal processing and/or application-specific integrated circuits.

Wrist-wearable device 600 with respect to FIG. 6 is an example of wearable band 610 and watch body 620 coupled together, so wrist-wearable device 600 will be understood to include the components shown and described for wearable band computing system 730 and watch body computing system 760. In some embodiments, wrist-wearable device 600 has a split architecture (e.g., a split mechanical architecture, a split electrical architecture, etc.) between watch body 620 and wearable band 610. In other words, all of the components shown in wearable band computing system 730 and watch body computing system 760 can be housed or otherwise disposed in a combined wrist-wearable device 600 or within individual components of watch body 620, wearable band 610, and/or portions thereof (e.g., a coupling mechanism 616 of wearable band 610).

The techniques described above can be used with any device for sensing neuromuscular signals but could also be used with other types of wearable devices for sensing neuromuscular signals (such as body-wearable or head-wearable devices that might have neuromuscular sensors closer to the brain or spinal column).

In some embodiments, wrist-wearable device 600 can be used in conjunction with a head-wearable device (e.g., AR system 800 and VR system 900) and/or an HIPD, and wrist-wearable device 600 can also be configured to be used to allow a user to control any aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable devices, attention will now be turned to example head-wearable devices, such AR and VR systems.

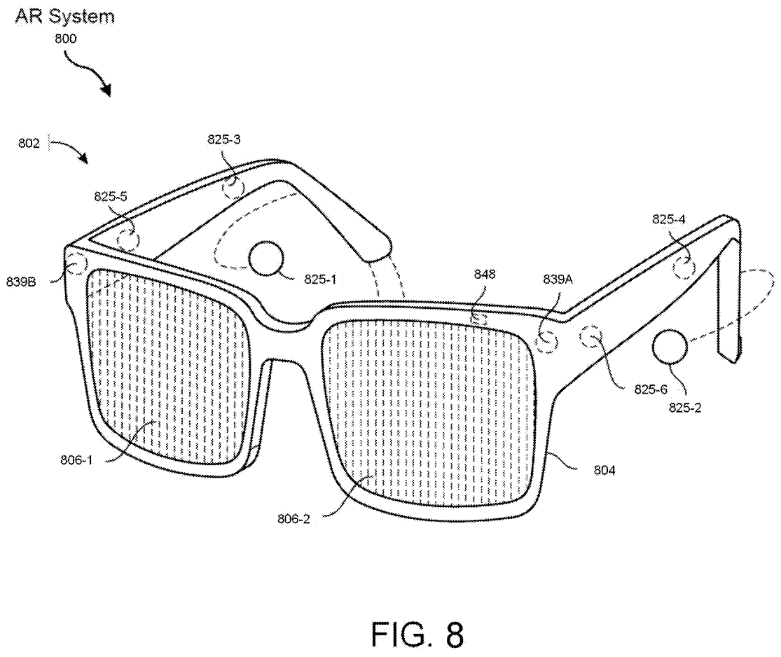

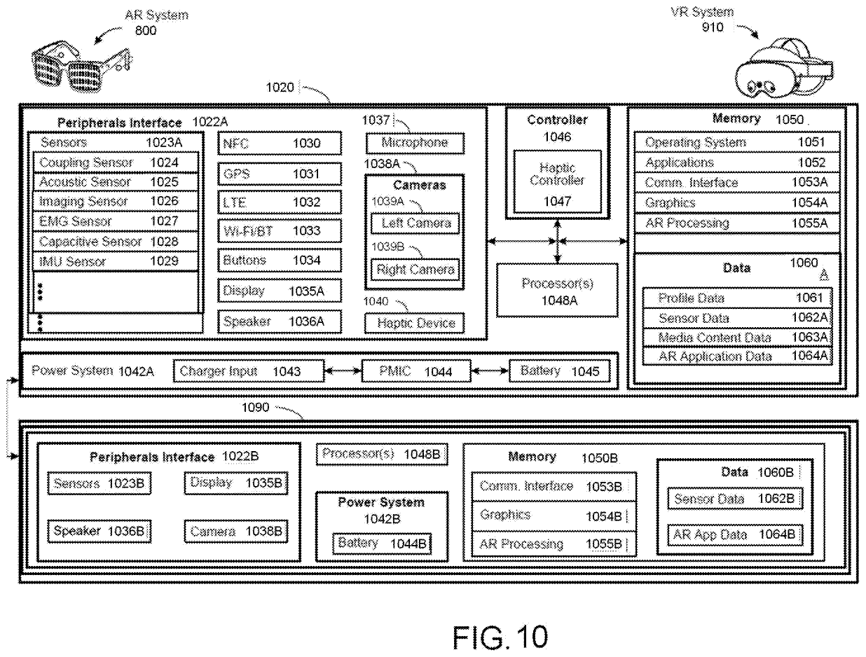

FIG. 8 is a schematic diagram illustrating an example of an augmented reality (AR) system using some aspects of the subject technology. FIG. 8 shows an example visual depiction of the AR system 800, including an eyewear device 802 (which may also be described herein as augmented-reality glasses, and/or smart glasses). AR system 800 can include additional electronic components that are not shown in FIG. 8, such as a wearable accessory device and/or an intermediary processing device, in electronic communication or otherwise configured to be used in conjunction with the eyewear device 802. In some embodiments, the wearable accessory device and/or the intermediary processing device may be configured to couple with eyewear device 802 via a coupling mechanism in electronic communication with a coupling sensor 1024 (FIG. 10), where coupling sensor 1024 can detect when an electronic device becomes physically or electronically coupled with eyewear device 802. In some embodiments, eyewear device 802 can be configured to couple to a housing 1090 (FIG. 10), which may include one or more additional coupling mechanisms configured to couple with additional accessory devices. The components shown in FIG. 8 can be implemented in hardware, software, firmware, or a combination thereof, including one or more signal-processing components and/or application-specific integrated circuits (ASICs).

Eyewear device 802 includes mechanical glasses components, including a frame 804 configured to hold one or more lenses (e.g., one or both lenses 806-1 and 806-2). One of ordinary skill in the art will appreciate that eyewear device 802 can include additional mechanical components, such as hinges configured to allow portions of frame 804 of eyewear device 802 to be folded and unfolded, a bridge configured to span the gap between lenses 806-1 and 806-2 and rest on the user's nose, nose pads configured to rest on the bridge of the nose and provide support for eyewear device 802, earpieces configured to rest on the user's ears and provide additional support for eyewear device 802, temple arms configured to extend from the hinges to the earpieces of eyewear device 802, and the like. One of ordinary skill in the art will further appreciate that some examples of AR system 800 can include none of the mechanical components described herein. For example, smart contact lenses configured to present artificial reality to users may not include any components of eyewear device 802.

Eyewear device 802 includes electronic components, many of which will be described in more detail below with respect to FIG. 10. Some example electronic components are illustrated in FIG. 8, including acoustic sensors 825-1, 825-2, 825-3, 825-4, 825-5, and 825-6, which can be distributed along a substantial portion of the frame 804 of eyewear device 802. Eyewear device 802 also includes a left camera 839A and a right camera 839B, which are located on different sides of the frame 804. Eyewear device 802 also includes a processor 848 (or any other suitable type or form of integrated circuit) that is embedded into a portion of the frame 804.

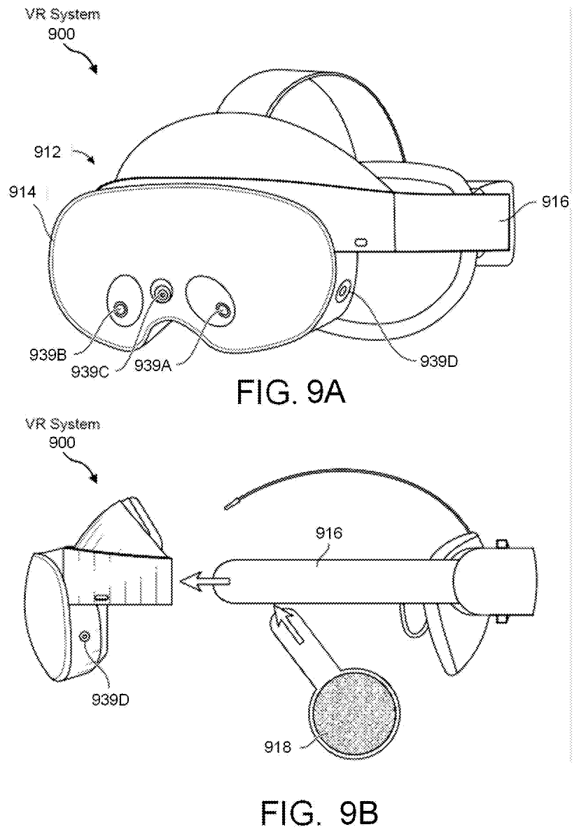

FIGS. 9A and 9B are schematic diagrams illustrating an example of a virtual reality (VR) system using some aspects of the subject technology. VR system 910 includes a head-mounted display (HMD) 912 (e.g., also referred to herein as an AR headset, a head-wearable device, a VR headset, etc.), in accordance with some embodiments. As noted, some AR systems (e.g., AR system 800) may, instead of blending an artificial reality with actual reality, substantially replace one or more of a user's visual and/or other sensory perceptions of the real world with a virtual experience (e.g., AR system 800).

HMD 912 includes a front body 914 and a frame 916 (e.g., a strap or band) shaped to fit around a user's head. In some embodiments, front body 914 and/or frame 916 include one or more electronic elements for facilitating presentation of and/or interactions with an AR and/or VR system (e.g., displays, IMUs, tracking emitters or detectors). In some embodiments, HMD 912 includes output audio transducers (e.g., an audio transducer 918), as shown in FIG. 9B. In some embodiments, one or more components, such as the output audio transducer(s) 918 and frame 916, can be configured to attach and detach (e.g., are detachably attachable) to HMD 912 (e.g., a portion or all of frame 916, and/or audio transducer 918), as shown in FIG. 9B. In some embodiments, coupling a detachable component to HMD 912 causes the detachable component to come into electronic communication with HMD 912.

FIGS. 9A and 9B also show that VR system 910 includes one or more cameras, such as left camera 939A and right camera 939B, which can be analogous to left and right cameras 839A and 839B on frame 804 of eyewear device 802. In some embodiments, VR system 910 includes one or more additional cameras (e.g., cameras 939C and 939D), which can be configured to augment image data obtained by left and right cameras 939A and 939B by providing more information. For example, camera 939C can be used to supply color information that is not discerned by cameras 939A and 939B. In some embodiments, one or more of cameras 939A to 939D can include an optional IR cut filter configured to remove IR light from being received at the respective camera sensors.

FIG. 10 is a diagram illustrating example block diagrams of a computing system corresponding to the AR device of FIG. 8 and the VR device of FIGS. 9A-9B. The system components include a computing system 1020 and an optional housing 1090, each of which show components that can be included in AR system 800 and/or VR system 910. In some embodiments, more or fewer components can be included in optional housing 1090 depending on practical restraints of the respective AR system being described.

In some embodiments, computing system 1020 can include one or more peripherals interfaces 1022A and/or optional housing 1090 can include one or more peripherals interfaces 1022B. Each computing system 1020 and optional housing 1090 can also include one or more power systems 1042A and 1042B, one or more controllers 1046 (including one or more haptic controllers 1047), one or more processors 1048A and 1048B (as defined above, including any of the examples provided), and memory 1050A and 1050B, which can all be in electronic communication with each other. For example, the one or more processors 1048A and 1048B can be configured to execute instructions stored in memory 1050A and 1050B, which can cause a controller of one or more of controllers 1046 to cause operations to be performed at one or more peripheral devices connected to peripherals interface 1022A and/or 1022B. In some embodiments, each operation described can be powered by electrical power provided by power system 1042A and/or 1042B.

In some embodiments, peripherals interface 1022A can include one or more devices configured to be part of computing system 1020, some of which have been defined above and/or described with respect to the wrist-wearable devices shown in FIGS. 6 and 7. For example, peripherals interface 1022A can include one or more sensors 1023A. Some example sensors 1023A include one or more coupling sensors 1024, one or more acoustic sensors 1025, one or more imaging sensors 1026, one or more EMG sensors 1027, one or more capacitive sensors 1028, one or more IMU sensors 1029, and/or any other types of sensors explained above or described with respect to any other embodiments discussed herein.

In some embodiments, peripherals interfaces 1022A and 1022B can include one or more additional peripheral devices, including one or more NFC devices 1030, one or more GPS devices 1031, one or more LTE devices 1032, one or more Wi-Fi and/or Bluetooth devices 1033, one or more buttons 1034 (e.g., including buttons that are slidable or otherwise adjustable), one or more displays 1035A and 1035B, one or more speakers 1036A and 1036B, one or more microphones 1037, one or more cameras 1038A and 1038B (e.g., including the left camera 1039A and/or a right camera 1039B), one or more haptic devices 1040, and/or any other types of peripheral devices defined above or described with respect to any other embodiments discussed herein.

AR systems can include a variety of types of visual feedback mechanisms (e.g., presentation devices). For example, display devices in AR system 800 and/or VR system 910 can include one or more liquid-crystal displays (LCDs), light emitting diode (LED) displays, organic LED (OLED) displays, and/or any other suitable types of display screens. AR systems can include a single display screen (e.g., configured to be seen by both eyes), and/or can provide separate display screens for each eye, which can allow for additional flexibility for varifocal adjustments and/or for correcting a refractive error associated with a user's vision. Some embodiments of AR systems also include optical subsystems having one or more lenses (e.g., conventional concave or convex lenses, Fresnel lenses, or adjustable liquid lenses) through which a user can view a display screen.

For example, respective displays 1035A and 1035B can be coupled to each of the lenses 806-1 and 806-2 of AR system 800. Displays 1035A and 1035B may be coupled to each of lenses 806-1 and 806-2, which can act together or independently to present an image or series of images to a user. In some embodiments, AR system 800 includes a single display 1035A or 1035B (e.g., a near-eye display) or more than two displays 1035A and 1035B. In some embodiments, a first set of one or more displays 1035A and 1035B can be used to present an augmented-reality environment, and a second set of one or more display devices 1035A and 1035B can be used to present a VR environment. In some embodiments, one or more waveguides are used in conjunction with presenting AR content to the user of AR system 800 (e.g., as a means of delivering light from one or more displays 1035A and 1035B to the user's eyes). In some embodiments, one or more waveguides are fully or partially integrated into the eyewear device 802. Additionally, or alternatively to display screens, some AR systems include one or more projection systems. For example, display devices in AR system 800 and/or VR system 910 can include micro-LED projectors that project light (e.g., using a waveguide) into display devices, such as clear combiner lenses that allow ambient light to pass through. The display devices can refract the projected light toward a user's pupil and can enable a user to simultaneously view both AR content and the real world. AR systems can also be configured with any other suitable type or form of image projection system. In some embodiments, one or more waveguides are provided additionally or alternatively to the one or more display(s) 1035A and 1035B.

Computing system 1020 and/or optional housing 1090 of AR system 800 or VR system 910 can include some or all of the components of a power system 1042A and 1042B. Power systems 1042A and 1042B can include one or more charger inputs 1043, one or more PMICs 1044, and/or one or more batteries 1045A and 1044B.

Memory 1050A and 1050B may include instructions and data, some or all of which may be stored as non-transitory computer-readable storage media within the memories 1050A and 1050B. For example, memory 1050A and 1050B can include one or more operating systems 1051, one or more applications 1052, one or more communication interface applications 1053A and 1053B, one or more graphics applications 1054A and 1054B, one or more AR processing applications 1055A and 1055B, and/or any other types of data defined above or described with respect to any other embodiments discussed herein.

Memory 1050A and 1050B also include data 1060A and 1060B, which can be used in conjunction with one or more of the applications discussed above. Data 1060A and 1060B can include profile data 1061, sensor data 1062A and 1062B, media content data 1063A, AR application data 1064A and 1064B, and/or any other types of data defined above or described with respect to any other embodiments discussed herein.

In some embodiments, controller 1046 of eyewear device 802 may process information generated by sensors 1023A and/or 1023B on eyewear device 802 and/or another electronic device within AR system 800. For example, controller 1046 can process information from acoustic sensors 825-1 and 825-2. For each detected sound, controller 1046 can perform a direction of arrival (DOA) estimation to estimate a direction from which the detected sound arrived at eyewear device 802 of AR system 800. As one or more of acoustic sensors 1025 (e.g., the acoustic sensors 825-1, 825-2) detects sounds, controller 1046 can populate an audio data set with the information (e.g., represented in FIG. 10 as sensor data 1062A and 1062B).

In some embodiments, a physical electronic connector can convey information between eyewear device 802 and another electronic device and/or between one or more processors 848, 1048A, 1048B of AR system 800 or VR system 910 and controller 1046. The information can be in the form of optical data, electrical data, wireless data, or any other transmittable data form. Moving the processing of information generated by eyewear device 802 to an intermediary processing device can reduce weight and heat in the eyewear device, making it more comfortable and safer for a user. In some embodiments, an optional wearable accessory device (e.g., an electronic neckband) is coupled to eyewear device 802 via one or more connectors. The connectors can be wired or wireless connectors and can include electrical and/or non-electrical (e.g., structural) components. In some embodiments, eyewear device 802 and the wearable accessory device can operate independently without any wired or wireless connection between them.

AR systems can include various types of computer vision components and subsystems. For example, AR system 800 and/or VR system 910 can include one or more optical sensors such as two-dimensional (2D) or three-dimensional (3D) cameras, time-of-flight depth sensors, structured light transmitters and detectors, single-beam or sweeping laser rangefinders, 3D LiDAR sensors, and/or any other suitable type or form of optical sensor. An AR system can process data from one or more of these sensors to identify a location of a user and/or aspects of the user's real-world physical surroundings, including the locations of real-world objects within the real-world physical surroundings. In some embodiments, the methods described herein are used to map the real world, to provide a user with context about real-world surroundings, and/or to generate digital twins (e.g., interactable virtual objects), among a variety of other functions. For example, FIGS. 9A and 9B show VR system 910 having cameras 939A to 939D, which can be used to provide depth information for creating a voxel field and a two-dimensional mesh to provide object information to the user to avoid collisions.

In some embodiments, AR system 800 and/or VR system 910 can include haptic (tactile) feedback systems, which may be incorporated into headwear, gloves, body suits, handheld controllers, environmental devices (e.g., chairs or floormats), and/or any other type of device or system, such as the wearable devices discussed herein. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback may be implemented using motors, piezoelectric actuators, fluidic systems, and/or a variety of other types of feedback mechanisms. The haptic feedback systems may be implemented independently of other AR devices, within other AR devices, and/or in conjunction with other AR devices.

In some embodiments of an artificial reality system, such as AR system 800 and/or VR system 910, ambient light (e.g., a live feed of the surrounding environment that a user would normally see) can be passed through a display element of a respective head-wearable device presenting aspects of the AR system. In some embodiments, ambient light can be passed through a portion that is less than all of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable device, and an amount of ambient light (e.g., 15-50% of the ambient light) can be passed through the user interface element such that the user can distinguish at least a portion of the physical environment over which the user interface element is being displayed.

An aspect of the subject technology is directed to a method that includes loading a conductive material to at least one extruder component connected to a die configured to produce a shape of a filament, and loading an insulative material to at least one additional extruder component connected to the die. The method further includes simultaneously extruding the conductive material and the insulative material through the separate channels of the die and curing the insulative material of the filament. The die comprises separate channels for conductive segments and insulative segments of the filament.

In some implementations, the method further comprises, prior to curing while extruding the conductive material and the insulative material, injecting additional conductive material and additional insulative material to the filament.

In one or more implementations, the method further comprises injecting the additional conductive material and the additional insulative material to the filament at predetermined intervals through the separate channels of the die.

In some implementations, the method further comprises customizing the conductive segments and the insulative segments of the filament by adjusting an injection of the additional conductive material and the additional insulative material through the separate channels.

In one or more implementations, the filament comprises at least one of a core, a shell, a first segment and a second segment.

In some implementations, the core comprises the conductive material, the shell comprises the insulative material, the first segment comprises an additional conductive material of the shell, and the second segment comprises an additional insulative material of the shell.

In one or more implementations, the method further comprises disposing at least one conductive pad at a surface of the filament for connecting a conductive pad to the second segment of the additional conductive material of the shell.

In some implementations, the method further comprises using the conductive pad to electronically couple an electrical component to the filament.

In one or more implementations, the method further comprises integrating the filament into a flexible fiber of an electronic device.

Another aspect of the subject technology is directed to a device that includes a customized insulated filament that consists of a core formed of a conductive material, a shell formed of an insulative material surrounding the core, and a plurality of conductive pads to connect to exposed segments of conductive material. The customized insulated filament is fabricated using an extrusion process.

In some implementations, the core and the shell are formed by extruding the conductive material and the insulative material into channels of a die.

In one or more implementations, a predetermined shape and size of the customized insulated filament is provided by a design of the channels of the die.

In some implementations, the exposed segments of the conductive material are formed at predetermined intervals along a length of the customized insulated filament.

In one or more implementations, the plurality of conductive pads are formed by injection of additional material at the exposed segments.

In some implementations, materials of the plurality of conductive pads, the shell and the core are immiscible to avoid mixing during extrusion.

In one or more implementations, the plurality of conductive pads are configured to electronically couple one or more electrical components to the customized insulated filament.

In some implementations, the customized insulated filament is flexible and is configured to be integrated into a flexible fiber of an electronic device.

Yet another aspect of the subject technology is directed to a wearable device that includes electronic circuitry and flexible electronic connectors including a customized insulated filament that consists of a core formed of a conductive material, a shell formed of an insulative material surrounding the core, and a plurality of conductive pads to connect to exposed segments of conductive material. The customized insulated filament is fabricated using an extrusion process and a die including multiple channels.

In one or more implementations, the core and the shell are formed by extruding the conductive material and the insulative material into the multiple channels of the die to provide a predetermined shape and size of the customized insulated filament, the exposed segments of the conductive material are formed at predetermined intervals along a length of the customized insulated filament, and the plurality of conductive pads are formed by injection of additional material at the exposed segments.

In some implementations, materials of the plurality of conductive pads, the shell and the core are immiscible to avoid mixing during extrusion, the plurality of conductive pads are configured to electronically couple one or more electrical components to the customized insulated filament, and the customized insulated filament is flexible and is configured to be integrated into flexible fibers of the wearable device.

In some implementations, the word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially described as such, one or more features from a described combination can in some cases be excised from the combination, and the described combination may be directed to a sub-combination or variation of a sub-combination.

The subject matter of this specification has been described in terms of particular aspects, but other aspects can be implemented and are within the scope of the following clauses. For example, while operations are depicted in the drawings in a particular order, this should not be understood as requiring that such operations be performed in the particular order shown or in sequential order, or that all illustrated operations be performed, to achieve desirable results. The actions recited in the clauses can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the clauses. In addition, in the detailed description, it can be seen that the description provides illustrative examples, and the various features are grouped together in various implementations for the purpose of streamlining the disclosure. The method of disclosure is not to be interpreted as reflecting an intention that the described subject matter requires more features than are expressly recited in each clause. Rather, as the clauses reflect, inventive subject matter lies in less than all features of a single disclosed configuration or operation. The clauses are hereby incorporated into the detailed description, with each clause standing on its own as a separately described subject matter.

As used herein, the phrase “at least one of” preceding a series of items, with the terms “and” or “or” to separate any of the items, modifies the list as a whole, rather than each member of the list (i.e., each item).

To the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A method comprising:
loading a conductive material to at least one extruder component connected to a die configured to produce a shape of a filament, wherein the die comprises separate channels for conductive segments and insulative segments of the filament;
loading an insulative material to at least one additional extruder component connected to the die;
simultaneously extruding the conductive material and the insulative material through the separate channels of the die; and
curing the insulative material of the filament.

2. The method of claim 1, further comprising, prior to curing while extruding the conductive material and the insulative material, injecting additional conductive material and additional insulative material to the filament.

3. The method of claim 2, further comprising injecting the additional conductive material and the additional insulative material to the filament at predetermined intervals through the separate channels of the die.

4. The method of claim 3, further comprising customizing the conductive segments and the insulative segments of the filament by adjusting an injection of the additional conductive material and the additional insulative material through the separate channels.

5. The method of claim 1, wherein the filament comprises at least one of a core, a shell, a first segment and a second segment.

6. The method of claim 5, wherein the core comprises the conductive material, the shell comprises the insulative material, the first segment comprises an additional conductive material of the shell, and the second segment comprises an additional insulative material of the shell.

7. The method of claim 6, further comprising disposing at least one conductive pad at a surface of the filament for connecting a conductive pad to the second segment of the additional conductive material of the shell.

8. The method of claim 7, further comprising using the conductive pad to electronically couple an electrical component to the filament.

9. The method of claim 1, further comprising integrating the filament into a flexible fiber of an electronic device.

10. A device comprising:
a customized insulated filament comprising:
a core formed of a conductive material;
a shell formed of an insulative material surrounding the core; and
a plurality of conductive pads to connect to exposed segments of conductive material,
wherein the customized insulated filament is fabricated using an extrusion process.

11. The device of claim 10, wherein the core and the shell are formed by extruding the conductive material and the insulative material into channels of a die.

12. The device of claim 11, wherein a predetermined shape and size of the customized insulated filament is provided by a design of the channels of the die.

13. The device of claim 10, wherein the exposed segments of the conductive material are formed at predetermined intervals along a length of the customized insulated filament.

14. The device of claim 10, wherein the plurality of conductive pads are formed by injection of additional material at the exposed segments.

15. The device of claim 14, wherein materials of the plurality of conductive pads, the shell and the core are immiscible to avoid mixing during extrusion.

16. The device of claim 10, wherein the plurality of conductive pads are configured to electronically couple one or more electrical components to the customized insulated filament.

17. The device of claim 10, wherein the customized insulated filament is flexible and is configured to be integrated into a flexible fiber of an electronic device.

18. A wearable device comprising:
electronic circuitry; and
flexible electronic connectors including a customized insulated filament comprising:
a core formed of a conductive material;
a shell formed of an insulative material surrounding the core; and
a plurality of conductive pads to connect to exposed segments of conductive material,
wherein the customized insulated filament is fabricated using an extrusion process
and a die including multiple channels.

19. The wearable device of claim 18, wherein:
the core and the shell are formed by extruding the conductive material and the insulative material into the multiple channels of the die to provide a predetermined shape and size of the customized insulated filament;
the exposed segments of the conductive material are formed at predetermined intervals along a length of the customized insulated filament; and
the plurality of conductive pads are formed by injection of additional material at the exposed segments.

20. The wearable device of claim 18, wherein:
materials of the plurality of conductive pads, the shell and the core are immiscible to avoid mixing during extrusion;
the plurality of conductive pads are configured to electronically couple one or more electrical components to the customized insulated filament; and
the customized insulated filament is flexible and is configured to be integrated into flexible fibers of the wearable device.
